(19) United States
(12) Patent Application Publication
(10) Pub. No.: US 2024/0278756 A1
(43) Pub. Date: Aug. 22, 2024

(54) VEHICLE, METHOD FOR CONTROLLING A BRAKE SYSTEM OF A VEHICLE, AND COMPUTER PROGRAM

(71) Applicant: Lightyear IPCo B.V., Helmond (NL)

(72) Inventors: Durandus Kornelius DIJKEN, Eindhoven (NL); Jaap VAN DE VORST, Nijmegen (NL)

(21) Appl. No.: 18/570,688

(22) PCT Filed: Jun. 29, 2022
(86) PCT No.: PCT/EP2022/067834

§ 371 Date: Dec. 15, 2023

(30) Foreign Application Priority Data
Jun. 29, 2021 (NL) 2028565

(51) Int. Cl. B60T 8/1761

(52) U.S. Cl. CPC B60T 8/1761

(57) ABSTRACT

There is provided a vehicle comprising a first axle and a brake system. The first axle supports a first wheel and a second wheel. The brake system comprises a brake control system, a first brake and a second brake. The first brake is arranged to apply a first brake force to the first wheel. The second brake is arranged to apply a second brake force to the second wheel. The brake control system is adapted to activate the first brake and the second brake in response to a braking signal representative of a desired brake force on the vehicle. The brake control system is adapted to activate both the first brake and the second brake simultaneously in a first situation in which the braking signal represents a desired brake force that is higher than a threshold value. The brake control system is adapted to activate only one of the first brake and the second brake simultaneously in a second situation.

The invention relates to a vehicle having an axle supporting a first wheel and a second wheel. The vehicle has a brake system with a first brake to apply a first brake force to the first wheel, and a second brake to apply a second brake force to the second wheel. The invention further relates to a method for controlling a brake system of a vehicle. Further, the invention relates to a computer program having instructions for execution by a brake system of a vehicle.

Vehicles such as cars, buses, trucks, and trains convert energy, such as electric energy or chemical energy, into motion to propel the vehicle. There is a trend to improve the efficiency with which these vehicles convert the energy into motion. The improved efficiency helps to reduce the costs per distance travelled with the vehicle, because the vehicle requires less fuel or less electricity per distance travelled. The improved efficiency helps to increase the action radius of a vehicle, which is especially beneficial for electric vehicles with a battery. Such a battery is typically large and heavy to store enough electric energy for a desired action radius of the electric vehicle. More efficiency allows the use of smaller batteries for the same action radius.

Several factors determine the efficiency with which the vehicle is able to convert energy into motion, such as drivetrain efficiency, wind resistance and roll resistance. As vehicles become more and more efficient, other factors become more dominantly visible in the overall efficiency of the vehicle. One of those factors is brake drag.

Brake drag is caused by the brake system. The brake system typically has a brake comprising a brake disc and a calliper. The brake disc is attached to a wheel. The calliper is adapted to contact the brake disc to create a brake force. When a brake force is desired to decelerate the vehicle, the brake is activated, causing the calliper and the brake disk to contact each other. When the brake force is no longer desired, the brake is deactivated. Ideally, the contact between the calliper and the brake disc should be broken. However, some contact between the calliper and the brake disc remains. This contact is undesired as it dissipates energy from the vehicle, which thereby reduces the efficiency of the vehicle. This loss of energy is referred to as brake drag. Brake drag may become worse over time as the brake wears and dirt accumulates between the brake disc and the calliper. For vehicles with an efficient drivetrain, brake drag may consume as much as 5% of the energy converted by the vehicle per distance travelled.

Some vehicles are provided with a brake drag monitor system to determine the amount of brake drag. Such a system is disclosed in PCT patent application WO2016073324. The known system determines whether the brake pedal of the vehicle is being operated. If the brake pedal is not being operated, the brake drag monitoring starts. The speed of each wheel is compared with a master speed signal, for example, the overall speed of the vehicle. If the speed of a wheel differs from the master speed value for a certain amount of time, the temperature of that wheel is checked. If the temperature exceeds a threshold, that wheel suffers from brake drag. The driver is then notified.

It is helpful to determine the amount of brake drag, to see whether the brake drag exceeds a threshold that represents an unacceptable amount. When the threshold is exceeded, the brake system may be cleaned or repaired. The threshold should be set rather high to prevent cleaning or repair of the brake system to occur too often. A disadvantage of the known brake drag monitoring system is that it does not help to reduce the brake drag that occurs before the threshold is exceeded.

It is an objective of the invention to provide a vehicle that is affected less by brake drag or to at least provide an alternative.

The objective of the invention is achieved by a vehicle comprising a first axle and a brake system. The first axle supports a first wheel and a second wheel. The brake system comprises a brake control system, a first brake and a second brake. The first brake is arranged to apply a first brake force to the first wheel. The second brake is arranged to apply a second brake force to the second wheel. The brake control system is adapted to activate the first brake and the second brake in response to a braking signal representative of a desired brake force on the vehicle. The brake control system is adapted to activate both the first brake and the second brake simultaneously in a first situation in which the braking signal represents a desired brake force that is higher than a threshold value. The brake control system is adapted to activate only one of the first brake and the second brake simultaneously in a second situation in which the braking signal represents a desired brake force that is lower than a threshold value.

In the first situation, the desired brake force is high, for example, when a large deceleration of the vehicle is desired. To create a large brake force to quickly decelerate the vehicle, both the first brake and the second brake are activated simultaneously.

In the second situation, the desired brake force is low, for example, when the vehicle is nearing a traffic light at a low speed with the intention to stop at the traffic light. Because only a small brake force is desired, it is sufficient to activate only one of the first brake and the second brake. The first brake and the second brake are not activated simultaneously in the second situation.

The inventors have discovered that the brake drag of a brake is at a high value at the moment the brake is deactivated, and that the high value reduces over a certain amount of time to a nominal value. Then the brake drag substantially remains at the nominal value. The certain amount of time is in the order of several seconds, for example 5 seconds or 10 seconds or 30 seconds. In the first situation, both the first brake and the second brake are activated. When deactivating the first brake and the second brake, both brakes temperately cause a large brake drag. However, this is acceptable because a high brake force was desired in the first situation. Also, by creating the high brake force with both brakes, the vehicle has a good stability during the brake action. In the second situation, only one of the brakes was actuated, so only that one brake causes a large brake drag after deactivating that one brake. As a result, the amount of brake drag is reduced compared to the situation in which both brakes were used. Because in the second situation, only a small brake force is desired, only one brake is sufficient to create the desired brake force. Because the brake force is only small, the stability of the vehicle is not at risk. For example, using only one brake in the second situation does not result in any yaw of the vehicle that is noticeable by the driver of the vehicle, or the yaw is hardly noticeable. When driving a vehicle, the second situation may often occur, especially in an urban environment, for example when nearing an intersection, nearing traffic lights, driving in a traffic jam or driving in a parking. As a result, using only one of the first brake and the second brake in the second situation may have a significant effect on the overall efficiency of the vehicle. Therefore, the vehicle is less affected by brake drag.

The vehicle is, for example, a wheeled vehicle, such as a car or a truck or a train or a tram or a metro. The wheels of the vehicle support the vehicle. The vehicle is, for example, adapted to rotate the wheels to propel the vehicle. Alternatively, the vehicle has other means of propelling the vehicle, such as a propeller or a cable as used for example in a funicular railway. In an example, the vehicle is an unpowered vehicle that is not able to propel on its own. The unpowered vehicle is, for example, a trailer or a railway carriage. An unpowered vehicle requires another vehicle to propel the unpowered vehicle.

The vehicle has the first axle that supports the first wheel and the second wheel. The first axle is arranged to allow the first wheel and the second wheel to rotate about an axis in a transverse direction of the vehicle. The first axle is, for example, formed by a single shaft that extends in the transverse direction. The first wheel and the second wheel are attached to the opposite ends of the single shaft. In an example, the single shaft is fixed to the body of the vehicle, and the first and second wheels are rotatably connected to the single shaft. In another example, the first and second wheels are fixed to the single shaft, whereas the single shaft is rotatably connected to the body of the vehicle. In an example, the first axle is not a single component. For example, the first axle is formed by two separated shafts that each supports one of the first and second wheels. The two separated shafts are aligned with each other in the transverse direction of the vehicle. By forming the first axle by two separate shafts, steering of the first and second wheels is, for example, allowed. When steering, the first and second wheels typically rotate a different amount along a vertical axis, which would be more restricted if the first axle is formed by a single shaft. In an example, the first wheel and the second wheel are individually attached to the body of the vehicle. In an example, the first axle comprises components for connecting and suspending the first wheel and the second wheel to the vehicle, such as an upright, a top wishbone, a bottom wishbone. In an example, the first axle supports additional wheels besides the first and second wheels, such as two additional wheels or four additional wheels. Such additional wheels are especially beneficial for heavy duty vehicles, like trucks.

Typically, a passenger car has a front axle and a rear axle. The front axle supports the two front wheels, which are steerable to steer the passenger car. The front wheels are aligned along the transverse direction. The front wheels are individually suspended to the body of the car. The rear axle supports the two rear wheels, which are not steerable. The first axle is, for example, the front axle or the rear axle. Many trucks have a single front axle and multiple rear axles. The first axle is, for example, the front axle or one of the rear axles.

In most applications, it is desirable to align the first wheel and the second wheel along the transverse direction of the vehicle. In some applications, however, it is possible to arrange the first wheel and the second wheel at an offset in the longitudinal direction of the vehicle. In this arrangement, the first wheel and the second wheel are not perfectly aligned along the transverse direction. The offset may be small compared to the size of the vehicle, for example less than a diameter of the first wheel.

The first and second wheels are for example wheels adapted to be used on a paved surface. The first and second wheels comprise, for example, a wheel rim on which a tyre is mounted. The first and second wheels comprise, for example, an inwheel motor arranged to drive the first wheel and/or the second wheel. An inwheel motor is alternatively known as hub motor. The first and second wheels are for example wheels adapted to be used on tracks, such as railroad tracks. In this example, the first and second wheels have a surface at their outer radius that is made of steel to contact the tracks. The first and second wheels are for example wheels adapted to be used in combination with caterpillar tracks. In this example, the first and second wheels are provided with protrusions to cooperate with the caterpillar tracks. For example, a rotation of the first wheel results in a movement of a caterpillar track on one side of the vehicle. A rotation of the second wheel results in the movement of another caterpillar track on the opposite side of the vehicle.

The brake system comprises a brake control system, a first brake and a second brake. The first brake is arranged to apply a first brake force to the first wheel. For example, the first brake comprises a calliper and a brake disc. The brake disc is arranged on the first wheel. The brake disc rotates together with the first wheel. The brake disc rotates relative to the calliper. For example, the calliper is arranged on the body of the vehicle or on the upright. When the first brake is activated, the calliper makes contact with the brake disc, for example, by pinching the brake disc or by pressing against the brake disc. The contact between the calliper and the brake disc causes a friction force between the calliper and the brake disc. This friction force is the first brake force. In another example, the first brake is a drum brake comprising a brake shoe and a brake drum. The brake drum is connected to the first wheel and rotates with the first wheel. The brake drum is rotatable relative to the brake shoe. When the first brake is activated, the brake shoe contacts the brake drum to create a friction force.

The second brake is arranged to apply a second brake force to the second wheel. For example, the second brake comprises a calliper and a brake disc. The brake disc is arranged on the second wheel. The brake disc rotates together with the second wheel. The brake disc rotates relative to the calliper. For example, the calliper is arranged on the body of the vehicle or on the upright. When the second brake is activated, the calliper makes contact with the brake disc, for example, by pinching the brake disc or by pressing against the brake disc. The contact between the calliper and the brake disc causes a friction force between the calliper and the brake disc. This friction force is the second brake force. In another example, the second brake is a drum brake comprising a brake shoe and a brake drum. The brake drum is connected to the second wheel and rotates with the second wheel. The brake drum is rotatable relative to the brake shoe. When the second brake is activated, the brake shoe contacts the brake drum to create a friction force. In an example, the first brake and the second brake are the same type of brake. In another example, the first brake and the second brake are different types of brakes.

The brake control system is adapted to activate the first brake and the second brake in response to a braking signal representative of a desired brake force on the vehicle. The brake control system comprises, for example, a control unit to activate the first and second brakes. The control unit comprises, for example, a microprocessor. The brake control system comprises, for example, one or more pressure valves to control a hydraulic pressure to the first brake and a hydraulic pressure to the second brake. The brake control system is adapted to increase the hydraulic pressure to the first brake to activate the first brake. The brake control system is adapted to increase the hydraulic pressure to the second brake to activate the second brake. The brake control system is adapted to decrease the hydraulic pressure to the first brake to deactivate the first brake. The brake control system is adapted to decrease the hydraulic pressure to the second brake to deactivate the second brake. The brake control system is, for example, adapted to control a brake actuator. The brake actuator, for example, moves the calliper relative to the brake disc. The brake actuator is adapted to press the calliper of the first brake against the brake disc of the first brake to activate the first brake. Another brake actuator is adapted to press the calliper of the second brake against the brake disc of the second brake to activate the second brake.

The braking signal is representative of a desired brake force. The desired brake force is, for example, determined by the driver of the vehicle. The driver wishes to reduce the speed of the vehicle with a certain amount or wishes to prevent the vehicle from moving. The driver's wish corresponds to a certain desired brake force. The driver communicates the wish with the brake control system, for example, by pressing on the brake pedal. The brake pedal, for example, increases a hydraulic pressure in the brake system. The higher the desired brake force, the more the driver presses the brake pedal, the higher the hydraulic pressure in the brake system. In another example, the brake pedal comprises a sensor, such as a pressure sensor. The sensor determines when and how hard the brake pedal is pressed by the driver. The sensor generates the braking signal based on how hard the brake pedal is pressed. The harder the brake pedal is pressed, the higher the desired brake force is.

In another example, the braking signal is generated by a cruise control system of the vehicle. The cruise control system is adapted to maintain the vehicle at a desired speed. In case the cruise control system determines that the speed of the vehicle exceeds the desired speed, for example when driving downhill, the cruise control system sends the braking signal to the brake control system to slow the vehicle down. In the situation in which the vehicle is driving too close behind another vehicle, the cruise control system is, for example, adapted to generate the braking signal to slow down the vehicle to increase the distance to the other vehicle.

In another example, the braking signal is generated by a collision avoidance system. The collision avoidance system is adapted to estimate whether a collision is likely to happen with the vehicle. For example, the collision avoidance system detects whether there is an object in front of the vehicle and how fast the vehicle and the object approach each other. If the object approaches too fast, the collision avoidance system estimates a collision may happen and generates the braking signal to slow the vehicle down in an attempt to avoid or mitigate the collision. When attempting to avoid a collision, the desired brake force is, for example, higher than the threshold, because a fast deceleration of the vehicle is desired.

In an example, the vehicle has the brake pedal and the cruise control system that each are able to generate the braking signal. In another example, the vehicle has the brake pedal, the cruise control system, and the collision avoidance system, that each are able to generate the braking signal.

The brake control system is adapted to activate both the first brake and the second brake simultaneously in the first situation. In the first situation, the braking signal represents a desired brake force that is higher than a threshold value. For example, the threshold value is 5% or 10% or 15% of the maximum brake force that the brake system is able to generate. For example, the brake system is adapted to generate a maximum deceleration of the vehicle of 1 g (9.81 m/s²). Via Newton's second law, F=m*a, the maximum deceleration of 1 g corresponds to a maximum brake force. For a passenger car of 2000 kg, the maximum brake force would be 19.6 kN. The threshold value is for example set at 1 kN or 1.5 kN or 2 kN or 3 kN.

In the following example the threshold value is 1 kN. The driver presses lightly on the brake pedal, which generates the braking signal as a result. Because the brake pedal is pressed only lightly by the driver, the braking signal represents a desired brake force of less than 1 kN. The brake control system activates only the first brake and does not activate the second brake. When the driver releases the brake pedal, the brake control system deactivates the first brake.

In the following example the threshold value is 1 kN. The driver presses lightly on the brake pedal, which generates the braking signal as a result. Because the brake pedal is pressed only lightly by the driver, the braking signal represents a desired brake force of less than 1 kN. The brake control system activates only the first brake and does not activate the second brake. Then the driver presses the brake pedal harder. This generates a braking signal representing a desired braking force that is higher than 1 kN. The brake control system activates both the first brake and the second brake. When the driver releases the brake pedal, the brake control system deactivates both the first brake and the second brake.

In an embodiment, the brake control system is adapted to alternate between activating the first brake and the second brake in the second situation.

According to this embodiment, the brake control system activates one of the first brake and the second brake in the second situation, for example the first brake. Because the first brake is used, the first brake wears, whereas the second brake is not used and does not wear or does not wear as much. To have the first brake and the second brake wear more evenly, the brake control system uses sometimes the first brake in the second situation and sometimes the second brake in the second situation. For example, during a brake action, the first brake is used. After the brake action is over and the first brake has been deactivated, the second brake is used in the next brake action. In another example, if a brake action in the second situation takes a long time, for example, when driving downhill for a long distance, the brake system changes from activating the first brake to activating the second brake or vice versa. This prevents excessive wear of only one of the first and second brakes.

In an embodiment, the vehicle comprises a second axle supporting a third wheel and fourth wheel. The brake system comprises a third brake and a fourth brake. The third brake is arranged to apply a third brake force to the third wheel. The fourth brake is arranged to apply a fourth brake force to the fourth wheel. The brake control system is adapted to activate the first brake, the second brake, the third brake and the fourth brake in the first situation simultaneously. The brake control system is adapted to activate only one of the third brake and the fourth brake simultaneously, in the second situation.

According to the embodiment, the vehicle has the first axle and the second axle. For example, the first axle is a front axle, whereas the second axle is a rear axle or vice versa. In the example that the vehicle is a truck, the first and second axles are, for example, rear axles. The second axle is, for example, constructed with similar components as the first axle. In another example, the first axle comprises two separated shafts, whereas the second axle comprises a single shaft, or vice versa. By braking with one wheel on the first axle and with one wheel on the second axle a larger brake force can be generated compared to only braking with one wheel on the first axle. Also, by braking with one wheel on the first axle and one wheel on the second axle, the dynamical stability of the vehicle can be improved compared to only braking with one wheel on the first axle. The improved dynamical stability is especially beneficial when braking at high speeds, such as more than 80 km/h or more than 100 km/h, and/or when the vehicle is a heavy vehicle, such as a truck or a train.

The third brake and the fourth brake are, for example, the same type of brakes as the first brake and the second brake. In another example, the third brake and the fourth brake are different types of brakes than the first brake and the second brake. For example, the first and second brakes are disc brakes, whereas the third and fourth brakes are drum brakes.

In an embodiment, the first wheel and the third wheel are arranged on one side of a longitudinal axis of the vehicle. The second wheel and the fourth wheel are arranged on an opposite side of the longitudinal axis. The brake control system is adapted to activate in the second situation only the first brake and the fourth brake simultaneously, or only the second brake and the third brake simultaneously.

According to the embodiment, the first wheel and the third wheel are arranged on one side of the vehicle, for example, the driver's side of the car. The second wheel and the fourth wheel are arranged on the opposite side of the vehicle, for example, the passenger's side of the car. When braking in the second situation with the first brake and the fourth brake, or with the second brake and the third brake, the brake forces are applied to the vehicle along a diagonal direction as seen from a top side of the vehicle. By applying the brake forces diagonally, the dynamic stability of the vehicle is improved. For example, the vehicle is less affected by yaw compared to braking with braking only one wheel. Optionally, the brake control system is adapted to alternate between activating in the second situation the first brake together with the fourth brake, and activating in the second situation the second brake together with the third brake.

In an embodiment, the vehicle comprises an electric motor for driving the first wheel or the second wheel. The electric motor is adapted to apply electric braking to the first wheel or the second wheel. During electric braking, the electric motor converts kinetic energy of the vehicle to electric energy. The brake control system is adapted to control the electric motor to apply electric braking in the first situation. The brake control system is adapted to control the electric motor not to apply electric braking in the second situation.

The electric motor is for example an inwheel motor arranged at least partly inside the first wheel. For example, the first wheel has an inwheel motor, and the second wheel has an inwheel motor. The electric motor is adapted to generate a torque to rotate the first wheel or the second wheel in response to an electric current or a voltage applied to the electric motor. In an example, the electric motor comprises magnets coupled to the first wheel. The electric motor provides electric braking by providing a metal plate, such as a copper plate or an aluminium plate, near the magnets. The magnets rotate together with the first wheel relative to the metal plate. The magnets create an alternating magnetic field in the metal plate, which creates Eddy currents. Because of the Eddy currents, energy is dissipated, causing the first wheel to slow down. In another example, the electric motor comprises coils. To drive the first wheel, the coils are provided with an electric current. The coils interact with the first wheel, for example via magnets or ferromagnetic material arranged on the first wheel, to create an electromagnetic force on the first wheel. The electromagnetic force rotates the first wheel. To apply electric braking, the electric motor is used as an electric generator. The rotation of the first wheel generates an electric current through the coils. This electric current is for example dissipated via an electrical resistance, or is used to charge a battery of the vehicle. This way, the kinetic energy of the first wheel is converted into electric energy, causing the first wheel to slow down.

Because electric braking is most effective at high speeds of the vehicle, electric braking is used in the first situation. When driving at a high speed, using all brakes improves the dynamic stability of the vehicle. However, when driving at a low speed, electric braking is less effective or not possible at all. When driving at a low speed, and when only a small brake force is desired, the braking of the vehicle is controlled better if no electric braking is applied.

In an embodiment, the vehicle comprises a brake drag monitor system for monitoring brake drag of the brake system. The brake drag monitoring system is adapted to determine an amount of brake drag based on a change of a parameter of the vehicle. The brake system is adapted to cause the change of the parameter by activating and then deactivating at least one of the first brake and the second brake.

According to this embodiment, the brake system activates and then deactivates at least one of the first and second brakes. When deactivating the brake or brakes, brake drag occurs. The brake drag monitor system uses a change of a parameter of the vehicle to monitor the brake drag. For example, the parameter is a temperature of the first brake or the second brake. For example, the parameter is a noise generated by the first brake or the second brake. For example, the parameter is a position of the calliper relative to the brake disc of the first brake or the second brake.

In an embodiment, the parameter is representative of an amount of power required to maintain the vehicle at a certain speed.

According to the embodiment, the vehicle requires a certain amount of power to maintain a certain speed. This certain speed is referred to as nominal speed in this example. The amount of power is substantially constant when, for example, driving on a levelled, straight road with the cruise control system engaged. If the brake system briefly activates and then deactivates the first brake, the vehicle increases the power to the motor to maintain the nominal speed. However, due to the brake drag of the first brake, the vehicle needs additional power to maintain the vehicle at the nominal speed than before braking with the first brake. The additional power reduces over time, because the brake drag reduces over time. The brake drag monitoring system uses information representative of the additional power to estimate the amount of brake drag. This information is for example fuel consumption per distance travelled, a value of an electric current applied through the electric motor, or a value of a voltage applied to the electric motor, or a difference in the charge of a battery providing electric power to the electric motor. In case the amount of power exceeds a threshold, the driver is, for example, notified that maintenance of the brake system is advised or required. The brake drag monitor system may take into account the steepness of the road, GPS-coordinates and weather conditions. For example, the brag drag monitor system notifies the driver of the vehicle to press the brake pedal briefly while the cruise control is engaged to start the monitoring of the brag drag. In a similar way, the brake drag monitor system is able to determine brag drag of the second brake, or any other brake.

In an embodiment, the parameter is representative of a deceleration of the vehicle.

According to this embodiment, the brake drag monitor system estimates a deceleration of a vehicle, for example when rolling the vehicle up to a red traffic light. In this case, no power is provided to the wheels of the vehicle. This deceleration is referred to as a nominal deceleration in this example. After the brake drag monitor system estimates the nominal deceleration, the brake system briefly activates and then deactivates the first brake, causing the first brake to create brake drag. The activation of the first brake causes the deceleration to increase. However, due to the brake drag, the deceleration after deactivating the first brake is higher than the nominal deceleration. The brake drag monitor system is adapted to determine the amount of brake drag by comparing the deceleration after deactivating the first brake with the nominal deceleration. Optionally, the brake drag monitor system is adapted to perform the comparison regularly when the vehicle is rolling without power being provided to the wheels. The brake drag monitor system may take into account the steepness of the road, GPS-coordinates and weather conditions. For example, the brag drag monitor system notifies the driver of the vehicle to press the brake pedal briefly while the vehicle is rolling with no power being provided to the wheels to start the monitoring of the brag drag. In a similar way, the brake drag monitor system is able to determine brag drag of the second brake, or any other brake.

In an embodiment, the brake drag monitoring system is adapted to control the brake control system to activate and then deactivate at least one of the first brake and the second brake in a third situation in which the braking signal represents that no desired brake force is desired.

According to this embodiment, the brake drag monitoring system is able to control the brake control system. For example, the brake drag monitoring system is configured to determine the amount of brake drag at regular intervals. When it is desired to determine the amount of brake drag, the brake drag monitoring system may control the brake control system to activate a brake in case there is no desired brake force. For example, the vehicle is moving at a constant speed with the cruise control engaged. The brake drag monitoring system uses, for example, GPS coordinates to obtain information that the road the vehicle is driving is straight and level. The brake drag monitoring decides to send a signal to the brake control system to briefly activate and then deactivate one or more of the brakes. The brake drag monitoring system then determines the brake drag based on the change of the parameter of the vehicle. If the brake drag exceeds a certain amount, the driver is notified that maintenance of the brake system is needed.

In an embodiment, the vehicle comprises a second axle supporting a third wheel and fourth wheel. The brake system comprises a third brake and a fourth brake. The third brake is arranged to apply a third brake force to the third wheel. The fourth brake is arranged to apply a fourth brake force to the fourth wheel. The brake control system is adapted to activate the first brake, the second brake, the third brake and the fourth brake. The brake drag monitor system is adapted to determine the amount of brake drag based on the change of the parameter in the third situation by controlling the brake system to activate and then deactivate a first selection of the first brake, the second brake, the third brake and the fourth brake, and afterwards activate and then deactivate a second selection of the first brake, the second brake, the third brake and the fourth brake. The first selection is different from the second selection.

According to this embodiment, the brake monitor system is adapted to activate and deactivate different groups of the brakes to determine the amount of brake drag. For example, in the first selection the first brake and the second brake are activated and then deactivated, whereas the third brake and the fourth brake are not activated. In the second selection the third brake and the fourth brake are activated and then deactivated, whereas the first brake and the second brake are not activated. By determining the brake drag of the selections of brakes, the brake monitor system may determine more quickly in case there is too much brake drag. It requires less time to, for example, determine if there is too much brake drag by dividing the four brakes into two selections, than to determine brake drag for each of the four brakes individually. For example, if the second brake suffers from a lot of brake drag, the brake monitor system is able to detect that by monitoring a selection of brakes that include the second brake. The brake drag monitor system does not need to monitor all brakes individually. In case a selection of brakes has too much brake drag, the brake drag monitor system is optionally adapted to determine the brake drag of the brakes in that selection individually to determine which brake suffers from the large brake drag.

In an embodiment, the first wheel and the third wheel are arranged on one side of a longitudinal axis of the vehicle. The second wheel and the fourth wheel are arranged on an opposite side of the longitudinal axis. The brake drag monitor system is adapted to determine the amount of brake drag based on the change of the parameter in the third situation by controlling the brake system to activate and then deactivate, the first selection, the second selection, a third selection of the first brake, the second brake, the third brake and the fourth brake, and a fourth selection of the first brake, the second brake, the third brake and the fourth brake. The third selection is different from the first selection and the second selection. The fourth selection is different from the first selection, the second selection, and the third selection.

According to this embodiment, the brake drag monitor system determines the brake drag based on four different selections of the brakes. Because there are four different selections, and there are four brakes (i.e., the first, second, third and fourth brakes), the brake drag monitor system is able to determine the amount of brake drag for each of the four brakes based on the four different selections. In an example, the first, second and third brakes form the first election. The second, third and fourth brakes form the second selection. The first, third and fourth brakes form the third selection. The first, second and fourth brakes form the fourth selection. In another example, the first and second brakes form the first election. The second and third brakes form the second selection. The first and third brakes form the third selection. The first and fourth brakes form the fourth selection.

In a further aspect of the invention, the invention is a method for controlling a brake system of a vehicle. The vehicle comprises a first axle supporting a first wheel and a second wheel. The brake system comprises a first brake and a second brake. The first brake is arranged to apply a first brake force to the first wheel. The second brake is arranged to apply a second brake force to the second wheel. The method comprises the steps of:
activating the first brake and the second brake simultaneously in a first situation in response to a braking signal representing a desired brake force on the vehicle that is higher than a threshold value, and
activating only one of the first brake and the second brake simultaneously in a second situation in response to the braking signal representing a desired brake force that is lower than a threshold value.

In an embodiment, wherein the vehicle comprises a second axle supporting a third wheel and a fourth wheel. The brake system comprises a third brake and a fourth brake. The third brake is arranged to apply a third brake force to the third wheel. The fourth brake is arranged to apply a fourth brake force to the fourth wheel. The method comprises the steps of:
activating the third brake and the fourth brake simultaneously in the first situation,
activating only one of the third brake and the fourth brake simultaneously in the second situation.

In an embodiment, the method comprises the steps of:
activating and then deactivating at least one of the first brake and the second brake;
determining a change of a parameter of the vehicle;
determine an amount of brake drag based on the change of the parameter.

In yet a further aspect of the invention, the invention is a computer program having instructions which, when executed by a brake system of a vehicle, cause the brake system to perform the method as described above.

The invention will be described in more detail below under reference to the figures, in which embodiments of the invention are shown. To indicate in the figures that a brake of a wheel is activated, the wheel is coloured a black. When a brake of a wheel is not activated or deactivated, the wheel is coloured white. The figures show in:

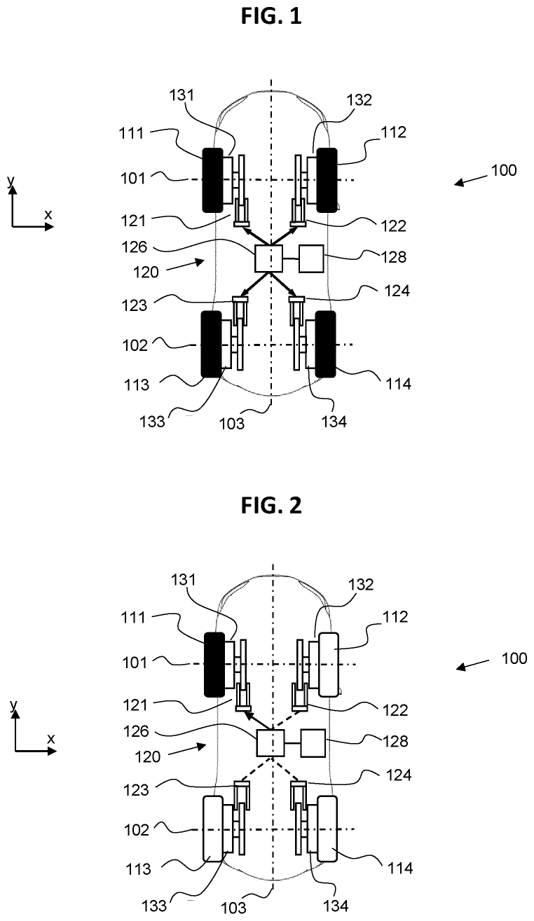

FIG. 1: a vehicle according to a first embodiment of the invention in a first situation.

FIG. 2: a vehicle according to the first embodiment of the invention in a second situation.

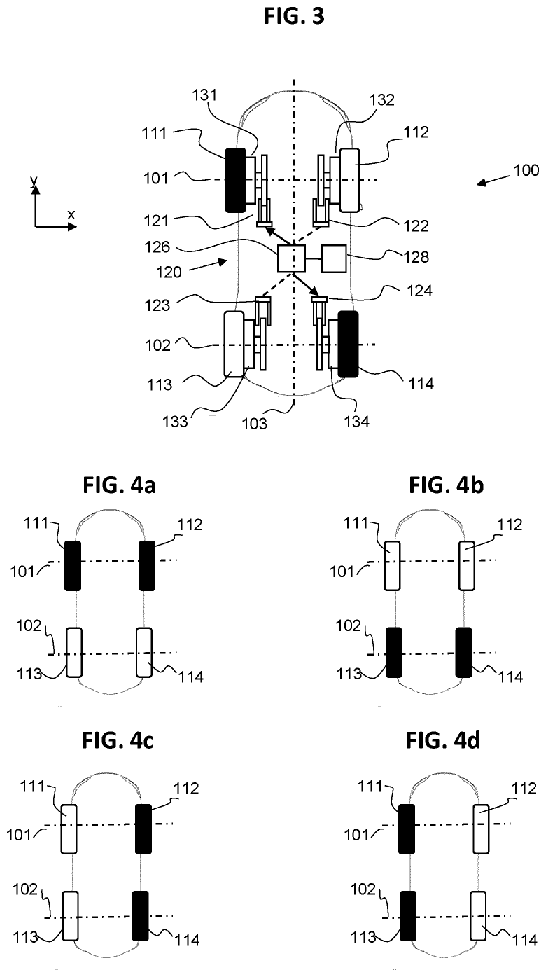

FIG. 3: a vehicle according to a second embodiment of the invention in the second situation.

FIGS. 4a-4d: a vehicle according to the invention in a third embodiment.

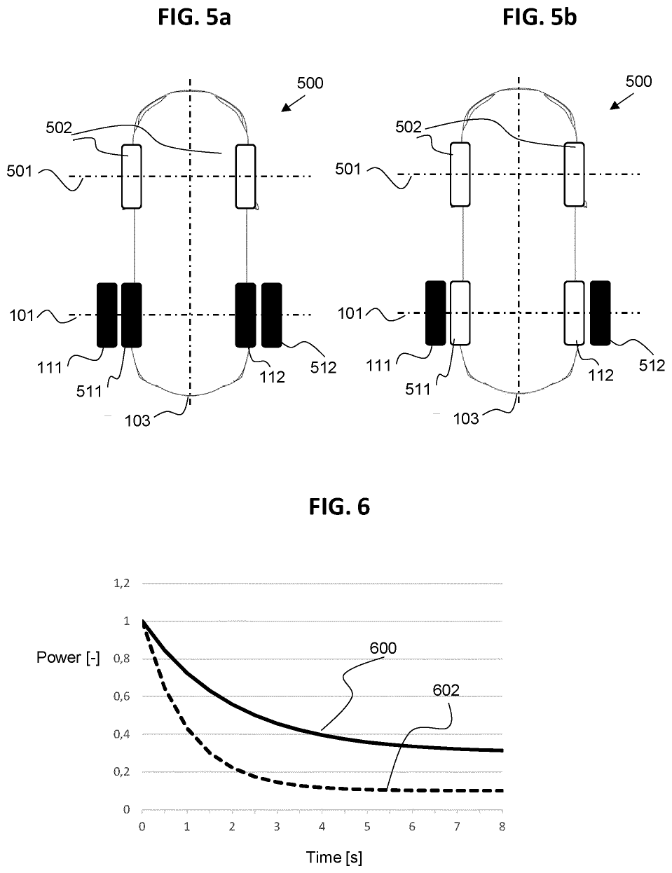

FIG. 5: a vehicle according to the invention in a fourth embodiment.

FIG. 6: a change of a parameter of the vehicle.

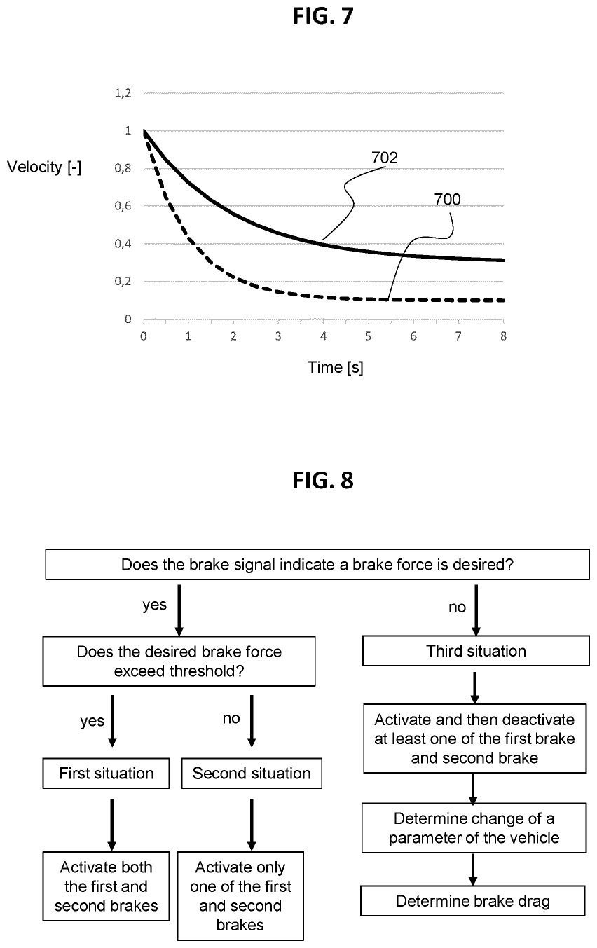

FIG. 7: a change of another parameter of the vehicle.

FIG. 8: a method according to an embodiment of the invention.

FIG. 1 depicts a vehicle 100 according to a first embodiment of the invention. The vehicle 100 comprises a first axle 101 and a second axle 102. The first axle 101 and the second axle 102 are represented as imaginary axes aligned along a transverse direction of the vehicle 100, i.e., the x-direction. The first axle 101 supports a first wheel 111 and a second wheel 112. The second axle 102 supports a third wheel 113 and a fourth wheel 114. The first axle 101 is the front axle, whereas the second axle 102 is the rear axle of the vehicle 100. The vehicle 100 has a longitudinal axis 103 along the longitudinal direction of the vehicle 100, i.e., the y-axis. The first wheel 111 and the third wheel 113 are arranged on one side of the longitudinal axis 103, i.e., on the left side of the longitudinal axis 103 in FIG. 1. The second wheel 112 and the fourth wheel 114 are arranged on the opposite side of the longitudinal axis 103, i.e., on the right side of the longitudinal axis 103 in FIG. 1.

The vehicle 100 has a brake system 120 comprising a brake control system 126, a first brake 121, a second brake 122, a third brake 123 and a fourth brake 124. Each of the first brake 121, second brake 122, third brake 123 and the fourth brake 124 comprises a calliper and a brake disc. Each brake disc is attached to a corresponding wheel of the first wheel 111, the second wheel 112, the third wheel 113 and the fourth wheel 114. The callipers are attached to a body of the vehicle 100, such that the brake discs rotate together with the wheels 111-114 along the imaginary axes relative to the callipers.

The first brake 121 is arranged to apply a first brake force to the first wheel 111. The second brake 122 is arranged to apply a second brake force to the second wheel 112. The brake control system 126 is adapted to activate the first brake 121 and the second brake 122 in response to a braking signal representative of a desired brake force on the vehicle 100.

The brake control system 126 is adapted to activate all of the first brake 121, the second brake 122, the third brake 123 and the fourth brake 124 simultaneously in the first situation. In the first situation, the braking signal represents a desired brake force that is higher than a threshold value. The brake control system 126 actuates all callipers to press against their corresponding brake discs, causing a large braking force to decelerate the vehicle 100.

The vehicle 100 comprises a brake drag monitor system 128 for monitoring brake drag of the brake system 120. The brake drag monitor system 128 is adapted to determine an amount of brake drag based on a change of a parameter of the vehicle 100. The brake system 120 is adapted to cause the change of the parameter by activating and then deactivating at least one of the first brake 121 and the second brake 122.

The vehicle 100 comprises a first electric motor 131 for driving the first wheel 111, a second electric motor 132 for driving the second wheel 112, a third electric motor 133 for driving the third wheel 113, and a fourth electric motor 134 for driving the fourth wheel 114. The electric motors 131-134 are adapted to apply electric braking to the wheels 111-114. During electric braking, the electric motors 131-134 convert kinetic energy of the vehicle 100 to electric energy. The brake control system 126 is adapted to control the electric motors 131-134 to apply electric braking in the first situation. The brake control system 126 is adapted to control the electric motors 131-134 not to apply electric braking in the second situation.

The brake drag monitor system 128 is adapted to control the brake control system 126 to activate and then deactivate at least one of the first brake 121 and the second brake 122 in a third situation in which the braking signal represents that no desired brake force is desired.

FIG. 2 depicts the vehicle 100 according to the first embodiment of the invention in a second situation. In the second situation, the braking signal represents a desired brake force that is lower than the threshold valve. The desired brake force is larger than zero, i.e., there is a desire to generate at least some brake force. The brake control system 126 is adapted to activate only the first brake 121 without simultaneously activating the second brake 122 on the first axle 101. In a next brake action, which occurs after the first brake 121 has been deactivated, the brake control system 126 is adapted to activate only the second brake 122, but not the first brake 121 in a next second situation. This way, the brake control system 126 is able to alternate between activating the first brake 121 and the second brake 122 in the second situation.

FIG. 3 depicts the vehicle 100 according to a second embodiment of the invention in the second situation. In this embodiment, the brake control system 126 is adapted to activate only one of the first brake 121 and the second brake 122, and to activate only one of the third brake 123 and the fourth brake 124 simultaneously in the second situation. The brake control system 126 activates the first brake 121 and the fourth brake 124 to generate a brake force on respectively the first wheel 111 and the fourth wheel 114. Because the first wheel 111 and the fourth wheel 114 are arranged on opposite sides of the longitudinal axis 103, and because the first wheel 111 and the fourth wheel 114 arranged on the first axle 101 and the second axle 102 respectively, the brake forces are applied to the vehicle 100 along a diagonal direction as seen from a top side of the vehicle 100.

FIGS. 4a-4d depict a vehicle 100 according to the invention in a third embodiment. These figures show a top view of the vehicle 100 in which the first axle 101, second axle 102 and the wheels are depicts. A wheel that has a corresponding brake that is activated, is coloured black. A wheel that has a corresponding brake that is not activated, is coloured white.

The brake drag monitor system 128 is adapted to determine the amount of brake drag based on the change of the parameter in the third situation by controlling the brake system 120 to activate and then deactivate different selections of the first brake 121, the second brake 122, the third brake 123 and the fourth brake 124.

In the first selection, which is shown in FIG. 4a, the first brake 121 and the second brake 122 are activated and then deactivated. In the second selection, which is shown in FIG. 4b, the third brake 123 and the fourth brake 124 are activated and then deactivated. In the third selection, which is shown in FIG. 4c, the second brake 122 and the fourth brake 124 are activated and then deactivated. In the fourth selection, which is shown in FIG. 4d, the first brake 121 and the third brake 123 are activated and then deactivated.

FIGS. 5a and 5b depict a vehicle 500 according to the invention in a fourth embodiment. The vehicle has a front axle 501 that supports two wheels 502. The rear axle is formed by the first axle 101. The first axle 101 supports the first wheel 111, the second wheel 112, and two additional wheels 511, 512. Additional wheel 511 is on the same side of the longitudinal axis 103 as the first wheel 111. Additional wheel 512 is on the same side of the longitudinal axis 103 as the second wheel 112. FIG. 5a depicts the first situation. In the first situation, the brake control system 126 activates the brakes for all wheels on the first axle 101, i.e., the first wheel 111, the second wheel 112 and the two additional wheels 511, 512. FIG. 5b depicts the second situation. In the second situation, the brake control system 126 activates the brakes for the first wheel 111 and the additional wheel 512, but not the brakes for the second wheel 112 and the additional wheel 511.

FIG. 6 depicts a parameter of the vehicle 100. The parameter is the amount of power required by the vehicle 100 to remain at a certain constant speed. When the vehicle 100 is driving at a constant speed the first brake 121 is activated. The first electric motor 131 requires more power to maintain the first wheel 111 at the constant speed. This amount of power is indicated with the dimensionless value of 1 on the y-axis of the graph. The y-axis represents a normalized power level. The x-axis represents time in seconds. When the first brake 121 is deactivated, the first electric motor 131 requires less power to maintain the first wheel 111 at the constant speed. The required power is reduced over time. Line 600 indicates the required power over time in case the first brake 121 is affected by brake drag. As shown with line 600, the required power reduces fast the first few seconds. After several seconds, the required power reduces less fast, and eventually becomes a constant value. The brake drag monitor system 128 compares the values of the line 600 with other information to estimate whether the amount of brake drag is acceptable or not. For example, the other information is line 602. Line 602 represents the required power over time due to brake drag of the first brake 121, in case the first brake 121 is newly installed. When newly installed, the first brake 121 does not have wear and is clean, so the first brake 121 has a minimal brake drag. The brake drag monitor system 128 compares line 600 with line 602. When the difference exceeds a threshold, the brake drag monitor system 128 generates a warning that the first brake 121 requires maintenance. In another embodiment, a similar line as line 600 is created based on the required power by all the wheels of the vehicle 100 to determine the amount of brake drag for the complete vehicle 100.

The brake drag monitor system 128 for example only uses a part of lines 600 and 602 to determine the amount of brake drag. For example, the brake drag monitor system 128 compares lines 600 and 602 for the first two seconds, and then activates the first brake 121 again to perform another comparison.

FIG. 7 depicts another parameter of the vehicle 100. The parameter is deceleration of the vehicle 100. The x-axis of FIG. 7 indicates time in seconds. The y-axis indicates a velocity of the vehicle 100 in a dimensionless value. When the vehicle 100 is driving along a straight and level road, the electric motors are deactivated, for example when nearing an intersection. As a result, the vehicle 100 starts to decelerate. Then the first brake 121 is activated and then deactivated, causing brake drag. The moment of deactivation of the first brake 121 takes place at time=0. The velocity is then 1 [-]. The velocity of the vehicle 100 over time reduces according to line 700.

The brake drag monitor system 128 compares the values of the line 700 with other information to estimate whether the amount of brake drag is acceptable or not. For example, the other information is line 702. Line 702 represents the velocity of the vehicle 100 when driving along a straight and level road, and the electric motors are deactivated, in case the first brake 121 is newly installed. For example, all brakes are newly installed. Because new brakes have less brake drag, the velocity of the vehicle 100 remains higher for a longer time than shown in line 700.

The brake drag monitor system 128 compares line 700 with line 702. When the difference exceeds a threshold, the brake drag monitor system 128 generates a warning that the first brake 121 requires maintenance.

The brake drag monitor system 128 for example only uses a part of lines 700 and 702 to determine the amount of brake drag. For example, the brake drag monitor system 128 compares lines 700 and 702 for the first two seconds, and then activates the first brake 121 again to perform another comparison.

Because the velocity according to lines 700 and 702 depends also on other factors than brake drag, such as roll resistance, wind resistance, and frictions is wheel bearings etc, it is beneficial to regularly perform the comparison between the lines 700 and 702.

FIG. 8 depicts a method according to an embodiment of the invention. A method controls the brake system 120 of a vehicle 100. The method comprises the step of determining whether the brake signal indicates a brake force is desired. If the brake signal indicates a brake force is desired, the method comprises the step of determining whether the desired brake force exceeds a threshold. If the desired brake force is higher than the threshold, the vehicle 100 is in the first situation. In the first situation, both the first brake 121 and the second brake 122 are activated to generate the desired high brake force. If the desired brake force is lower than the threshold, the vehicle 100 is in the second situation. In the second situation, only one of the first brake 121 and the second brake 122 is activated. The other one of the first brake 121 and the second brake 122 is not activated.

In case the brake signal indicates that no brake force is desired, or when no brake signal is generated, the vehicle is in the third situation. The brake drag monitor system 128 is adapted to activate and then deactivate at least one of the first brake 121 and the second brake 122. The activation and deactivation of the at least one of the first brake 121 and the second brake 122, causes a parameter of the vehicle 100 to change. The change of the parameter of the vehicle 100 is determined. Based on the change of the parameter, the brake drag monitor system 128 determines the brake drag.

1. A vehicle comprising:
a first axle supporting a first wheel and a second wheel;
a brake system comprising a brake control system, a first brake and a second brake,
wherein the first brake is arranged to apply a first brake force to the first wheel,
wherein the second brake is arranged to apply a second brake force to the second wheel,
wherein the brake control system is adapted to activate the first brake and the second brake in response to a braking signal representative of a desired brake force on the vehicle,
wherein the brake control system is adapted to activate both the first brake and the second brake simultaneously in a first situation in which the braking signal represents a desired brake force that is higher than a threshold value,
wherein the brake control system is adapted to activate only one of the first brake and the second brake simultaneously in a second situation in which the braking signal represents a desired brake force that is lower than a threshold value.

2. The vehicle according to claim 1, wherein the brake control system is adapted to alternate between activating the first brake and the second brake in the second situation.

3. The vehicle according to claim 1, comprising a second axle supporting a third wheel and fourth wheel,
wherein the brake system comprises a third brake and a fourth brake,
wherein the third brake is arranged to apply a third brake force to the third wheel,
wherein the fourth brake is arranged to apply a fourth brake force to the fourth wheel,
wherein the brake control system is adapted to activate the first brake, the second brake, the third brake and the fourth brake in the first situation simultaneously,
wherein the brake control system is adapted to activate only one of the third brake and the fourth brake simultaneously, in the second situation.

4. The vehicle according to claim 3,
wherein the first wheel and the third wheel are arranged on one side of a longitudinal axis of the vehicle,
wherein the second wheel and the fourth wheel are arranged on an opposite side of the longitudinal axis,
wherein the brake control system is adapted to activate in the second situation only the first brake and the fourth brake simultaneously, or only the second brake and the third brake 123 simultaneously.

5. The vehicle according to claim 1, comprising an electric motor for driving the first wheel or the second wheel,
wherein the electric motor is adapted to apply electric braking to the first wheel or the second wheel,
wherein during electric braking, the electric motor converts kinetic energy of the vehicle to electric energy,
wherein the brake control system is adapted to control the electric motor to apply electric braking in the first situation,
wherein the brake control system is adapted to control the electric motor not to apply electric braking in the second situation.

6. The vehicle according to claim 1, comprising a brake drag monitor system for monitoring brake drag of the brake system,
wherein the brake drag monitor system is adapted to determine an amount of brake drag based on a change of a parameter of the vehicle,
wherein the brake system is adapted to cause the change of the parameter by activating and then deactivating at least one of the first brake and the second brake.

7. The vehicle according to claim 6, wherein the parameter is representative of an amount of power required to maintain the vehicle at a certain speed.

8. The vehicle according to claim 6, wherein the parameter is representative of a deceleration of the vehicle.

9. The vehicle according to claim 6, wherein the brake drag monitor system is adapted to control the brake control system to activate and then deactivate at least one of the first brake and the second brake in a third situation in which the braking signal represents that no desired brake force is desired.

10. The vehicle according to claim 9, comprising a second axle supporting a third wheel and fourth wheel,
wherein the brake system comprises a third brake and a fourth brake,
wherein the third brake is arranged to apply a third brake force to the third wheel,
wherein the fourth brake is arranged to apply a fourth brake force to the fourth wheel,
wherein the brake control system is adapted to activate the first brake, the second brake, the third brake and the fourth brake,
wherein the brake drag monitor system is adapted to determine the amount of brake drag based on the change of the parameter in the third situation by controlling the brake system to activate and then deactivate a first selection of the first brake, the second brake, the third brake and the fourth brake, and afterwards activate and then deactivate a second selection of the first brake, the second brake, the third brake and the fourth brake, wherein the first selection is different from the second selection.

11. The vehicle according to claim 10, wherein the first wheel and the third wheel are arranged on one side of a longitudinal axis of the vehicle,
wherein the second wheel and the fourth wheel are arranged on an opposite side of the longitudinal axis,
wherein the brake drag monitor system is adapted to determine the amount of brake drag based on the change of the parameter in the third situation by controlling the brake system to activate and then deactivate,
the first selection,
the second selection,
a third selection of the first brake, the second brake, the third brake and the fourth brake, wherein the third selection is different from the first selection and the second selection, and,
a fourth selection of the first brake, the second brake, the third brake and the fourth brake, wherein the fourth selection is different from the first selection, the second selection, and the third selection.

12. A method for controlling a brake system of a vehicle,
wherein the vehicle comprises a first axle supporting a first wheel and a second wheel,
wherein the brake system comprises a first brake and a second brake,
wherein the first brake is arranged to apply a first brake force to the first wheel,
wherein the second brake is arranged to apply a second brake force to the second wheel,
wherein the method comprises the steps of:
activating the first brake and the second brake simultaneously in a first situation in response to a braking signal representing a desired brake force on the vehicle that is higher than a threshold value,
activating only one of the first brake and the second brake simultaneously in a second situation in response to the braking signal representing a desired brake force that is lower than a threshold value.

13. The method according to claim 12,
wherein the vehicle comprises a second axle supporting a third wheel and a fourth wheel,
wherein the brake system comprises a third brake and a fourth brake,
wherein the third brake is arranged to apply a third brake force to the third wheel,
wherein the fourth brake is arranged to apply a fourth brake force to the fourth wheel,
wherein the method comprises the steps of:
activating the third brake and the fourth brake simultaneously in the first situation,
activating only one of the third brake and the fourth brake simultaneously in the second situation.

14. The method according to claim 12, comprising the steps of:
activating and then deactivating at least one of the first brake and the second brake;
determining a change of a parameter of the vehicle;
determine an amount of brake drag based on the change of the parameter.

15. A computer program having instructions which, when executed by a brake system of a vehicle, cause the brake system to perform the method according to claim 12.
